(19) United States
(12) Patent Application Publication
(10) Pub. No.: US 2007/0017113 A1
(43) Pub. Date: Jan. 25, 2007

(54) Efficiency dehumidifier drier with reversible airflow and improved control

(76) Inventors: Eric William Scharpf, Port Chalmers (NZ); Cederic Gerald, Dunedin (NZ); Zhifia Sun, Dunedin (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/547,109

(22) PCT Filed: Mar. 1, 2004
(86) PCT No.: PCT/NZ04/00039

§ 371 Date: Jul. 27, 2006

(30) Foreign Application Priority Data
Feb. 28, 2003 (NZ) 524471
Feb. 28, 2003 (NZ) 524469
Feb. 28, 2003 (NZ) 524470

(51) Int. Cl. F26B 19/00; F26B 3/00

(52) U.S. Cl. 34/86; 34/468

(57) ABSTRACT

An apparatus and process including a heat sink exchanger (26) to cool and condense liquid out of a drying gas with a heat transfer surface arranged to exchange heat with a first sub-stream of the drying gas and a heat source heat exchanger (27) arranged to exchange heat with a second sub-stream of a drying gas and arranged in a functionally parallel configuration with said heat sink heat exchanger (26) so that each of said drying gas sub-streams exchanges heat with one of the two said heat transfer surface per cycle through the heat exchange system and a gas movement device (35) for propelling the drying gas through the heat exchanger system in either a forward or reverse flow path direction. The apparatus and process can also include controlling the amount of heat rejected from apparatus (26) based on maintaining the wet bulb of the drying gas nominally constant and controlling the amount of refrigerant in the heat exchanger circuit based on maintaining the dry bulb temperature of the drying gas within certain limits.

### FIELD OF THE INVENTION

The present invention relates to the drying of materials using a heat pump or heat integrated dehumidifier system to move energy to evaporate liquid from wet material. It has particular application to the drying of timber but is also well suited for numerous other drying processes.

### BACKGROUND TO THE INVENTION

Most milled timber and many other materials dried on an industrial scale are currently dried by kilns operating on a heat-and-vent principle where ambient air is heated by indirect contact with steam or by some other high temperature heat source, passed over the timber or other material to be dried, and vented back to the atmosphere. This process is often relatively rapid but energy inefficient. Alternative drying methods using heat pump based drying systems have been generally known in industrial applications including timber drying for a number of years but they have had varying degrees of success based on limitations in performance, control and efficiency.

References to the use of heat pump refrigeration cycles in clothes drying date back to the 1940s in U.S. Pat. No. 2,418,239. Because of the complexities of both the drying process itself and the operation of a nominally closed loop drying system driven by a heat pump dehumidifier, there has been a need to provide active control of the process to both maintain its peak efficiency throughout the drying process and to ensure the quality of the dried product. This need is complicated by the fact that the control of a heat pump dehumidifier system and the drying process parameters themselves are linked by multiple feed-back processes that are fundamentally different from the more commonly practiced but less efficient heat-and-vent drying systems. Another of the key features of heat pump drying systems has been their inherent energy efficiency. The energy crisis of the 1970s focussed attention on energy efficiency and several items of prior art from just after this period reflect this focus.

One further problem that has developed more recently as part of the high drying speed is that the characteristics of the dried material are less suitable to the end users of the dried product. In the case of timber, these difficulties include kiln brown stain and internal checking. (Kreber, Haslett, McDonald, 1999; Bannister, Carrington, Chen, 2002) As a result, slower lower temperature drying methods have increased in favour because the loss of production speed is compensated for by the better quality dried product. (Bannister, Carrington, Chen, 2002)

Another problem is the uneven drying that results when the hot drying gas, typically air, is passed over the material to be dried in a single direction throughout the process. Material that is exposed to the hot drying gas first dries more quickly than the material further downstream in the configuration and can become over-dry on one side and under-dry on the other, with adverse quality implications. This problem is normally avoided in heat-and-vent kilns by reversing the drying gas flow direction (Keey, Langrish, Walker, 2000). Because of the fundamental simplicity of the heat-and-vent process, the airflow can easily be reversed periodically. One such system is that described by Rosenau in U.S. Pat. No. 4,356,641. Here a reversible air flow configuration is augmented by a switchable control system to better accommodate the reversible air flow. Another such system is described in U.S. Pat. No. 5,276,980 by Carter and Sprague which uses a complex air handling system with multiple drying chamber sections. However this problem of uneven drying is still present in heat pump driven kilns because the heat pump design has so far prevented any efficient reversing of the drying gas flow during operation.

Another problem that is present with heat-and-vent kilns is their fundamentally poor energy efficiency. The efficiency specifically decreases when the operating temperature is lowered in response to quality requirements. The productivity also decreases as the temperature is reduced (Keey, Langrish, Walker, 2000). Although they can sometimes be driven with waste heat systems, low temperature heat-and-vent systems typically require a high capital investment relative to their productivity which diminishes their attractiveness. (Bannister, Chen, Grey, Carrington, Sun, 1997)

Despite a higher inherent efficiency relative to heat and vent systems, heat pump based drying systems have also focussed their development on further improving this inherent efficiency through a variety of different improvements. One example of previous methods to address the problem of improving energy efficiency over a wider range of operating conditions is described by Lewis in U.S. Pat. No. 4,250,629. As with most efficient heat pump systems this is a closed loop process which heats the air before it enters a drying chamber and then removes some of the moisture from the air after it leaves the drying chamber before it is largely recirculated and goes through the process again. This system has the specific capability of air bypass controls on the heat pump allowing independent control of airflow through or around the heat pump evaporator to improve the range of temperatures over which the heat pump cycle can operate efficiently. However, the controls and louvers in such a system will need to be positioned in the active drying gas flow path which tends to increase the pressure drop through the drying gas circuit which cuts into the efficiency gains for the process. Another unsatisfactory aspect is that having critical mechanical moving parts in the kiln reduces system reliability. Louver type airflow controls tend to fail in the aggressive environment and this can result in damage to the product or the heat pump.

An example of improvements specifically targeted at efficiency is put forward by Thompson in NZ 213728. He describes a heat pump timber drying process and apparatus which uses multiple chambers and a heat reservoir to improve drying efficiency. Although effective from an efficiency perspective, the capital cost and operating difficulties associated with such a system are a significant disadvantage.

Goodwin and Hogue in U.S. Pat. No. 5,138,773 address the energy efficiency aspects of timber drying from the universal perspective of dry wall insulation materials for the kiln chamber. Their apparatus for insulation will improve the efficiency of both heat pump and non-heat pump based drying systems.

Goodwin in U.S. Pat. No. 5,595,000 proposed efficiency improvements to a partially recirculating dehumidification system which has some applicability to a heat pump driven system but does not specifically indicate such an application. These efficiency improvements are based on adding a connected set of heat exchangers to recover sensible heat more efficiently from the drying gas stream. A first heat exchanger removes sensible heat from the drying gas medium upstream of a second cold heat exchanger condensing moisture from the drying gas medium and then the majority of that heat removed in the first exchanger is returned to the drying medium in a third exchanger downstream of the second cold exchanger. Blundell (1979) has described the use of such a heat recovery system for increasing the drying efficiency of a heat pump dehumidifier, and data on the performance of such a dryer was presented by Bansal, Bannister and Carrington (1997).

U.S. Pat. No. 6,209,223 by Dinh describes a grain drying system with a heat pump configuration which employs additional recovery of waste heat from an internal combustion engine in series with the heat pump condenser as a means of heating the drying gas medium more efficiently.

All of these efforts to improve the efficiency of heat pump and dehumidifier drying processes indicate a clear and continuing focus on this inherent problem with all drying systems. Just as with the effort to reduce the capital cost of a drying apparatus, the effort to improve its efficiency is never completely finished. As such, if an efficiency improvement is of low cost and high value relative to existing technology, it will be a useful invention.

As implied by the work of Lewis in U.S. Pat. No. 4,250,629 it has become apparent that the performance of a heat pump drier depends critically on the temperature and humidity of the recirculating drying gas medium. As described by Carrington, Bannister, Bansal and Sun (1995), the performance of a traditional heat pump drying system can be optimised for a particular set of conditions, but this set of operating parameters is likely to be sub-optimal at other conditions.

Aspects of this performance problem were noted as early as 1943 in U.S. Pat. No. 2,332,981 by Anderson specifically relating to railroad car air conditioning systems. He worked to address this through an evaporator with an adjustable surface area where the configuration is designed to have all of the air to be cooled flowing across all of the active evaporator area for all of the area variations. While effective in the air conditioning application, this functionally series configuration is not flexible enough to work effectively in heat pump drying applications.

U.S. Pat. No. 4,596,123 by Cooperman attempts to address the performance problem caused by varying heat source conditions for a heat pump heating system through the use of a segmented evaporator to deliver “a substantially constant quantity of extracted heat to the condenser via the refrigerant substantially independently of the environmental temperature” based on sensing the pressure of the refrigerant between the evaporator and the compressor or the electric current demand of the compressor. Cooperman's work clearly improves the performance of a heat pump system with an ambient air heat source where a constant quantity of heat is required at the condenser but this is not suitable for a heat pump drying system which has widely varying requirements on the heat pump condenser side as well. There is no capacity to vary the heat output through the condenser or the flow of refrigerant through it.

U.S. Pat. No. 5,253,482 by Murway also has a multiple section evaporator heat pump system with an ambient air heat source to maintain a constant rate of heat recovery to the high temperature sink similar to the system by Cooperman only based on maintaining a precisely set saturation pressure and temperature of the refrigerant in the circuit. As for Cooperman's work, maintaining a strictly constant supply of heat is not well suited for drying applications. Also, there is no capacity to vary the heat output through the condenser or the flow of refrigerant through it.

U.S. Pat. No. 6,138,919 by Cooper and Rawhouser also propose a multiple section evaporator system with an ambient air heat source for heating swimming pools similar to both Murway and Cooperman's systems. Again, there is no capacity to vary the heat output through the condenser or the flow of refrigerant through it.

The difficulty with these last three attempts to improve heat pump performance through evaporator area control is that they are specifically designed for use in open environments and to provide a constant supply of heat through the condenser. In drying applications, there are two key differences relevant to the present invention. The first is that the heat source stream is the drying gas flow and there must be condensation of moisture to remove the moisture vapour from the process which requires a new configuration for the variable evaporator area. The second is that the heat flow required from the condenser drops off significantly as the material dries. This makes such open heat source, constant heat supply rate designs present in the prior art ill suited for drying applications. It is therefore, one object of the present invention to provide method and means to improve the efficiency and performance of a heat pump dehumidifier suitable for use in the variable demand conditions of a material drying system.

Another problem with many existing heat and vent kiln systems is the highly prominent vapour plume associated with the warm wet drying gas vented from the unit. In lumber drying these emissions typically contain volatile organic products, including hazardous air pollutants such as formaldehyde. The concentration levels of formaldehyde emissions from high temperature Pinus radiata kilns can be high compared with work-place emission standards in New Zealand (Keey, Langrish, Walker, 2000). Even when it does not contain polluting components, the vapour plume is a clear indication of industrial activity that has become undesirable in many situations.

Although heat pump based systems with essentially closed loop drying gas configurations essentially solve the plume problem, they do not possess other desirable characteristics of the heat and vent systems.

One of these specific characteristic problems with heat pump driven systems is the difficulty in reversing the drying gas flow in the drying chamber to promote even drying of the material as is done for heat-and-vent driers. This problem results from the specific configuration of the heat pump condenser, which condenses the heat pump working fluid and heats the recirculating drying gas stream, and the heat pump evaporator, which evaporates the heat pump working fluid and removes some of the moisture from the recirculating drying gas stream by cooling it and inducing water condensation. With the typical sequential series configuration in the existing heat pump and heat integrated dehumidifier technology, moisture laden drying gas enters the refrigerant evaporator and loses some of its moisture by condensation before it then passes to the refrigerant condenser to be reheated. Drying gas flow cannot be reversed in this system without dramatically reducing the drying capacity and efficiency, since it would result in the evaporator wastefully recooling part of the heated drying gas from the condenser and removing less moisture relative to the amount of heat removed. Because drying gas flow reversal in the existing dehumidifiers is not practical, some dehumidifier timber kiln operators have attempted to overcome the problem of uneven drying by leaving the kiln fans running for long periods without running the dehumidifier, in order to even-up the moisture content of the boards in different parts of the stack. But this reduces the kiln production rate and efficiency and thus reduces its profitability.

U.S. Pat. No. 4,182,048 by Wolfe and Hinton describe a general method for drying wood in reversible air drying gas flow with a heat pump system but provide no details of the method by which the heat pump evaporator and condenser heat or cool the air stream to provide the dehumidification. The only specifics they provide relate to the temperature and humidity of the drying air in the wood drying chamber and the time spent at those nominal conditions. Without any details of the method of the heat pump dehumidification of the air or any claims relating to an apparatus to conduct their method, the problem remains.

The reversible air circulation system in U.S. Pat. No. 5,276,980 by Carter and Sprague is nominally applicable to heat pump systems but still has problems with its application. In this system the heat pump is located outside the kiln chamber. One difficulty with this system is the capital cost of the complex air drying gas ducting system required for air off-take and return, and the cost of operating the fans needed to deliver the required air volumes. Similarly they provide no details on any associated heat pumping method or apparatus.

U.S. Pat. No. 6,021,644 by Ares and Lakdawala has a related heat pump configuration where they reverse the flow direction of the refrigerant working fluid but this is focussed on defrosting the heat pump evaporator coils rather than providing a reversing drying gas flow for industrial drying processes.

U.S. Pat. No. 6,209,223 by Dinh describes a grain drying system with an optional heat pump configuration used to provide a hot air drying gas stream. The system they propose is based on single pass operation for the air drying gas. In their preferred embodiment, the drying gas is first cooled and then reheated in sequence. The system has no capability of reversible drying gas flow nor does it provide for any recirculation or regeneration of the drying gas stream in a closed or semi-closed loop configuration. Thus it must continually take in a full stream of fresh ambient drying gas and heat it up to the operating conditions. As a result, in all but extremely high temperature ambient conditions, their unit is not able to operate as efficiently as a closed loop system.

There also have been several attempts to address this problem in the heat-and-vent technology that are generally relevant to this invention. It is important to note that they only relate to drying processes where the drying gas enters the process, is heated to increase its moisture uptake capacity, passes across the material being dried to take up some of the moisture, and a substantial portion of the moisture laden gas is then vented from the process, while the remaining balance is typically reheated and re-circulated into the material inlet air-stream. This heat-and-vent process is fundamentally different from a nominally closed loop system where the drying gas is cooled and its vapour-phase moisture content partially condensed to increase its moisture uptake capacity, heated to provide energy for further moisture evaporation, and passed across the material to be dried where it takes up more moisture before it is recycled through the process again and again with only minor purge and make-up streams removed and added to control various gas compositions. As such, these other attempts to control heat-and-vent processes do not address the problem for high efficiency heat pump driven systems with nominally closed loop drying gas recycle streams.

One such attempt to improve heat-and-vent drying control has been put forward by Rosenau in U.S. Pat. No. 4,356,641. This patent describes a heat-and-vent drier focussed on maintaining an acceptable constant rate of drying for lumber. This system provides control by sampling the moisture content of the lumber to determine the rate of change of moisture content in the lumber stack, and then adjusts the rate of drying if required by varying the drying gas wet bulb temperature set point. The difference between the actual wet bulb and the desired set point controls the rate of drying gas venting or a steam spray injection. The dry bulb temperature is also used to help control the system in that the difference between the measured value and the set point is used to control the heat input rate from the kiln heater. Aside from not considering the option for a recirculating drying gas system driven by a heat pump dehumidifier, the method changes the wet bulb temperature of the drying gas to control the drying rate which can involve other difficulties discussed further in the detailed description of the invention.

Another example of control technology applied to traditional heat-and-vent timber kiln drying efficiency was put forward by Gelineau and Kinney in U.S. Pat. No. 4,599,808. Their system improves drying efficiency by trying to maintain a constant rate of drying through maintaining a constant dry bulb temperature difference in the drying gas flow before and after it passes over the material being dried. Again, this method does not address the operational limits and opportunities associated with a heat pump driven system.

Another example of control technology applied to the traditional heat-and-vent timber kiln process was put forward by Moren and Ab in U.S. Pat. No. 5,940,984. They use the temperature difference across the timber stack as the measured variable to control the process. Although they follow a schedule with a nominally constant wet bulb temperature in the drying gas during the main part of the drying process, they decrease the wet bulb temperature at the end of the process which would cause difficulties with a heat pump dehumidification process. Since there is no heat pump dehumidification addressed in this work, it is also not able to address the efficiency issues associated with the simultaneous control of a heat pump dehumidifying system. In addition, since heat and vent systems typically run with higher heat transfer per pass of drying gas, the drying gas temperature change as it passes over or through the material being dried is higher and more easily used as a control variable. With the lower temperature differences present in heat pump dehumidification systems, this is not a practical measured variable for control and thus the problem remains.

One example of previous methods to address the problem of heat pump drier control is described by Lewis in U.S. Pat. No. 4,250,629. As with most efficient heat pump systems this is a closed loop process which heats the air before it enters a drying chamber and then removes some of the moisture from the air after it leaves the drying chamber before it is largely recirculated and goes through the process again. This control system is focussed on increasing the range of drying gas dry bulb temperatures over which the system can operate and provides this control by measuring the dry bulb temperature of the drying gas in the vicinity of the heat pump evaporator and then acts to vary the amount of air drying gas bypass around the heat pump evaporator according to this dry bulb temperature. The dry bulb temperature of the drying gas is the measured variable used to manipulate the amount of heat rejected from the kiln chamber and thus is related to the control of the overall drying rate of the system. This method has the disadvantage that, as the product dries and the wet bulb temperature falls in response, the dehumidifier drying capacity also falls, typically reducing the drying rate and the drying efficiency unnecessarily. Such systems require active intervention to repeatedly adjust the dry bulb set point as the drying process advances to sustain the productivity and efficiency of the system. The timing of these adjustments is critical. If the temperature is increased too early, the product may be damaged and lose value. If the adjustment takes place too late, the drying time will be unnecessarily extended, with accompanying loss of productivity and increased drying costs.

Another example of heat pump drier control has been put forward by Thompson in NZ 213728. He describes a heat pump timber drying process and apparatus which uses multiple chambers and a heat reservoir with a generalised control system based on dry bulb and wet bulb temperatures of the drying gas stream. This control system is focussed on maintaining a desired dry bulb temperature and relative humidity in the drying chamber rather than focussing on optimising the performance of the heat pump in the context of the drying process. The control strategy suffers from similar limitations to those of Lewis in U.S. Pat. No. 4,250,629 and as a result does not fully address the problem of integrated control of the drying process and the heat pump system.

In heat pump dehumidifier drying applications, the drying gas flow is primarily or fully in recirculation and there is a key difference with respect to the prior art relevant to the present invention. This difference relates to the fact that the heat flow required from the condenser drops off significantly as the material approaches its final dry state under batch drying conditions as practiced in the prior art. The corresponding method of heat pump and process control must therefore consider the best way to address this situation in the context of both the limitations and capabilities of the heat pump as well as the characteristics of the moisture release from the material being dried. This makes such single focus control designs present in the prior art open to the improvements proposed in the present invention. It is therefore, an object of the present invention to provide an improved control method and means to increase the efficiency and performance of a heat pump dehumidifier suitable for use in the variable demand conditions of a material batch drying system.

Thus there is a continuing need to improve both the control and efficiency of heat integrated and heat pump based drying systems as well as a need to economically and efficiently address the problems with the single direction drying gas flow inherent with heat pump and heat integrated systems that lead to unevenly dried product.

### SUMMARY OF THE INVENTION

It is an object of the invention to provide a heat pump and/or heat integrated drying apparatus and/or process which provides a clear improvement to one or more of the current practice problems of: the inability to effectively and efficiently provide even drying through reverse flow in heat integrated or heat pump driven drying apparatus and/or processes, the limited efficiency of existing heat integrated and heat pump driven drying apparatus and/or processes, and/or the limited ability to provide control of heat pump driven drying apparatus and/or processes which efficiently or effectively addresses the integration of the operation of the heat pump and the inherent nature of the drying process

In one aspect the present invention may be said to consist of a heat exchange apparatus operable in a drying apparatus with reversible drying gas flow including a cold heat exchanger and a hot heat exchanger arranged such that during operation the heat exchangers lie in a functionally parallel configuration relative to the drying gas flow, whereby a first sub-stream of the drying gas flow substantially exchanges heat with only the cold heat exchanger, and a second sub stream of the drying gas flow substantially exchanges heat with only the hot heat exchanger.

More particularly the invention may be said to comprise a heat exchange system for a drying apparatus, including:

a heat sink heat exchanger to cool and condense liquid out of a drying gas, with a heat transfer surface arranged to exchange heat with a first sub-stream of the drying gas, and

a heat source heat exchanger to heat the drying gas, with a heat transfer surface arranged to exchange heat with a second sub-stream of the drying gas, and arranged in a functionally parallel configuration with said heat sink heat exchanger so that each of said drying gas sub-streams exchanges heat with one of the two said heat transfer surfaces per cycle through the heat exchange system, and

a gas movement device for propelling the drying gas through or around the heat sink and heat source heat exchangers in either a forward or a reverse flow path direction.

Preferably at least part of the heat source heat exchanger is a condenser in a heat pump system. Preferably at least part of the heat sink heat exchanger is an evaporator in the heat pump system.

Preferably the heat exchange system is arranged to heat the drying gas to a temperature between 25 and 90C.

Preferably the system includes a gas flow path arranged to substantially mix the two gas streams after they have passed through or around said heat sink and heat source heat exchangers.

Preferably the system includes a control system arranged to reverse the drying gas flow direction based on any one or more of drying time, moisture content, wet or dry bulb temperature or relative humidity of the drying gas, or integrated amount of moisture removed from the drying gas.

In one form said heat sink heat exchanger contains a heat sink medium to cool and condense liquid out of the drying gas, with a heat sink heat transfer surface comprising two or more sections connected in a functionally parallel configuration with each other arranged to exchange heat with two or more substreams of the drying gas so that each drying gas sub-stream exchanges heat with no more than one of the two or more said heat sink heat transfer surface sections per cycle through the heat exchange system.

A control system is arranged to control the flow of heat sink medium in the heat sink heat exchanger sections and increase, decrease, turn on, and/or turn off the flow of heat exchange medium independently in each of the heat sink heat exchanger sections.

In another aspect the present invention may be said to consist of a drying apparatus with reversible drying gas flow including a drying chamber for material to be dried and a heat exchange apparatus, wherein the heat exchange apparatus includes a cold heat exchanger and a hot heat exchanger arranged such that during operation the heat exchangers lie in a functionally parallel configuration relative to the drying gas flow, whereby a first sub stream of the flow substantially exchanges heat with only the cold heat exchanger, and a second sub stream of the flow substantially exchanges heat with only the hot heat exchanger.

In another aspect, the present invention may be said to consist in a process of and/or apparatus for drying a material including: propelling a drying gas through and/or over a) the material, b) a condenser of a heat pump and c) a variable heat exchange area of the heat pump which evaporates refrigerant and which divides the drying gas into two or more sub streams which pass over at least some of the evaporator heat exchange area in a functionally parallel configuration and at least part of this evaporator heat exchange can be controlled to make it either more or less active for heat exchange as well as controlling both the refrigerant flow in the heat pump and the total active evaporator heat exchange area to assist in optimising the efficiency of drying the material.

More particularly the invention comprises a process for drying a material using a drying gas including:

causing a first sub-stream of the drying gas to flow through a heat sink heat exchanger to cool and condense liquid out of the drying gas, with a heat transfer surface arranged to exchange heat with a first sub-stream of the drying gas, causing a second sub-stream of the gas to flow through a heat source heat exchanger to heat the drying gas, with a heat transfer surface arranged to exchange heat with said second sub-stream of the drying gas, said heat source heat exchanger being arranged in a functionally parallel with said heat sink heat exchanger so that each of said drying gas sub-streams exchanges heat with one of the two said heat transfer surfaces per cycle through the heat exchange system, and causing the flow direction of the drying gas through the heat sink and heat source heat exchangers to reverse.

In another aspect the present invention may be said to consist in a heat pump including a working fluid circuit with a refrigerant, a means of compressing a variable flow of refrigerant, a condenser, variable heat exchange area which evaporates refrigerant and which has at least some area in a functionally parallel configuration relative to the flow of a heat source medium and at least part of which can be controlled to make it either more or less active for heat exchange, and a controller for operating the means of compression and the evaporator heat exchange area in a manner to assist in optimising efficiency during operation.

In another aspect the present invention may be said to consist in a heat pump including: a working fluid circuit with a refrigerant, one or more compressors in the circuit for compressing the refrigerant, a condenser in the circuit for exchanging heat between the refrigerant and a heat sink medium, variable evaporator heat exchange area in the circuit for exchanging heat between the refrigerant and a heat source medium and which has at least some area in a functionally parallel configuration relative to the flow of a heat source medium and at least part of which can be controlled to make it either more or less active for heat exchange, and a controller for selectively increasing or decreasing compressor functionality to control refrigerant flow rate through the circuit and thus also the amount of heat moved by the heat pump between the evaporator and the condenser and the power consumed by the heat pump, and for increasing or decreasing the active evaporator heat exchange area to control heat exchange between the refrigerant and the heat source medium.

Also, in reducing the active area for heat exchange at the evaporator, the fraction of heat source medium flow over that active heat exchange area relative to the total heat source medium flow is reduced. Thus at least some of the variable heat exchanger area would be configured in a functionally parallel manner so that when the active area for heat exchange is reduced, the fraction of the total flow of the heat source medium in heat exchange with the active evaporator area is also reduced. For example if the active evaporator heat exchange area is cut by some fraction, the heat source medium flow path would be left as it was before the active area was reduced so that part of the heat source medium flows over the remaining active area while the rest continues to flow over the inactive area in an effective bypass of the remaining active area.

In another aspect the present invention may be said to consist in a method of operating a heat pump for drying a material including: sensing a wet-bulb temperature and dry-bulb temperature in a drying gas flow, in a first drying stage after initial heat-up, controlling the rate of heat rejection from the drying gas flow to maintain the wet-bulb temperature substantially constant and allow the dry-bulb temperature to rise to increase the driving force for moisture removal and thus maintain the rate of moisture removal from the system for a longer part of the process, and in a second drying stage when the dry-bulb temperature reaches a limit, also controlling refrigerant flow through the heat pump to vary the rise in or maintain the dry-bulb temperature and optionally vary the wet bulb temperature to adjust the driving force for moisture removal from the material being dried to control the quality of the material being dried.

In another aspect the present invention may be said to consist in an apparatus for drying a material including: a chamber for a material, a heat pump for drying the material using a drying gas flow, sensors for detecting wet-bulb and dry-bulb temperatures of the drying gas flow, and a controller for controlling operation of the heat pump based on wet-bulb and dry-bulb temperatures, wherein the controller operates the heat pump to: a) in a first drying stage after initial heat-up, control the rate of heat rejection from the drying gas flow, to maintain the wet-bulb temperature substantially constant and allow the dry-bulb temperature to rise to increase the driving force for moisture removal and thus maintain the rate of moisture removal from the system for a longer part of the process, and in a second drying stage when the dry-bulb temperature reaches a limit, control refrigerant flow through the heat pump to vary the rise in or maintain the dry-bulb temperature and optionally vary the wet bulb temperature to adjust the driving force for moisture removal from the material being dried to control the quality of the material being dried.

Optionally, the moisture removal rate is also sensed to assist in controlling the heat rejection rate and refrigerant flow through the heat pump to optimise drying.

The heat exchange apparatus may be a heat pump with an evaporator and condenser as the hot and cold heat exchangers respectively. Alternatively, the heat exchange apparatus may utilise other integrated heat exchange technology. For example, other heat sinks and sources may be used to augment or replace the heat pump evaporator and condenser.

Preferably, the invention provides the even drying benefits of a traditional reversing heat-and-vent method and system plus the energy efficiency and other related benefits of a heat pump or heat integrated method and system as well as the benefits of improved integrated control of both the heat pump and drying process.

A preferred embodiment of the invention consists of a heat pump drying process and apparatus configured so that the heat pump condenser and evaporator are located entirely within the kiln chamber and work effectively with the primarily closed loop recirculating air-flow (or other drying gas medium) in either direction. This system is combined with the method and means to reverse that drying gas flow. The method and apparatus of the invention conducts the drying gas cooling and moisture condensation heat exchange at the heat pump evaporator and the drying gas heating heat exchange at the heat pump condenser in a configuration functionally parallel to the drying gas flow rather than in a sequential series configuration as is done with conventional heat pump dehumidifier drying systems. Thus the drying gas is split into two or more sub streams in a functionally parallel configuration such that at least one sub stream exchanges heat with only the heat pump evaporator and at least one other sub stream exchanges heat with only the heat pump condenser.

Preferably, compressor functionality in the heat pump circuit (refrigerant flow) can be selectively increased or decreased by a clear means of control associated with the compressor system. Individual compressors within the compression system may also be selectively shut off or turned on as a means of controlling the refrigerant flow in the heat pump circuit. Controlling refrigerant flow controls the rate of heat gain by the refrigerant from the drying gas through the evaporator area, thus controlling cooling of the drying gas. Controlling refrigerant flow also controls the rate of heat transfer to the drying gas by the refrigerant through the condenser, thus controlling heating of the drying gas. Controlling the refrigerant flow also helps control the power consumed by the process so matching the refrigerant flow to the needs of the drying system will improve the overall efficiency of the drying process.

Preferably, the evaporator variable heat exchange area can be selectively increased or decreased by operating refrigerant control valves associated with the evaporator areas, to activate and de-activate them as required. Other control mechanisms could also be envisaged, however within the scope of this invention. In this manner, the variation in heat exchange area is such that sections of heat exchange area, in a functionally parallel configuration relative to the drying gas medium, are put into and out of active heat exchange service with the drying gas medium. The evaporator variable heat exchange area may be formed from one evaporator with multiple sections that can be activated or de-activated as required, or multiple independent evaporators that can be independently activated or de-activated. Multiple independent evaporators may also each comprise multiple sections, each of which can be activated or de-activated.

It is also preferable to configure this variable evaporator heat exchange area such that two or more of the sub streams of drying gas pass over separate sections of the evaporator heat exchange area. The effective evaporator heat exchange area is then adjusted according to the specific drying gas flow configuration such that the drying gas flowing across the active evaporator area is always cooled sufficiently to condense and remove liquid from the drying gas in combination with adjusting total refrigerant flow through the compression system while keeping the total effective heat pump condenser heat exchange area in the drying gas stream constant. This will have the initial benefit of keeping the evaporating and condensing temperatures within the allowed ranges for the compressor system. This will also have the benefit of driving the drying process at higher efficiency over a range of drying conditions since it will enable the wasteful excess moisture removal capacity of the heat pump system to be turned down, while keeping the evaporating temperature at the optimum value for efficient operation as the material dries and inherently releases moisture more slowly. Another benefit is realised by keeping the condenser fully active throughout the drying process which mininises the condensing temperature difference so the efficiency of the system is kept near its maximum as the drying gas temperature rises during the drying process. This enables the operating temperature to be increased to increase the driving force for drying, while remaining within the compressor operating limits, when the inherent drying rate naturally drops off later in the drying process.

Thus with this preferred embodiment, the performance of the drier can be optimised during the start of the drying process at high heat pump loads when the temperature is lowest, and the humidity highest using a high refrigerant flow in the heat pump and a large active evaporator area. Yet the present invention will still permit the drier to operate effectively and efficiently at high temperatures and low humidity under low heat pump loads, as required to complete the drying process as fast and efficiently as possible using a lower refrigerant flow, lower active evaporator area, and higher active condenser area per unit refrigerant flow and also permit heat transfer to enable the higher dry bulb temperatures for the drying gas flow to be achieved more efficiently and the moisture from the drying gas stream to continue to condense and be removed from the process. Furthermore, all of this is accomplished without disrupting the drying gas flow or negatively affecting the pressure drop in the drying gas circuit.

In the preferred embodiment, the control of the heat rejected from the drying process is based on the wet bulb temperature of the drying gas such that the wet bulb temperature is kept nominally constant for an extended period during the drying process and the flow of refrigerant in the heat pump is controlled based on the dry bulb temperature of the drying gas such that the dry bulb temperature is kept within certain limits throughout the drying process.

In optional embodiments, it is possible to use a waste heat source to supplement or replace the heat pump condenser and a waste heat sink such as cooling water to supplement or replace the heat pump evaporator. It is also possible to run the drying gas in a more open loop configuration where part or all of the sub stream passing over the heat pump evaporator or other cold exchanger is vented from the process after transferring and recycling heat back to the process through that heat pump evaporator or other cold exchanger while a fresh drying gas sub stream is introduced as make up to the process to replace that which is vented.

In the preferred embodiments of the invention, in each pass through the heat pump system, part of the drying gas passes over the heat pump evaporator where some of the moisture is condensed out and part of the drying gas passes over the heat pump condenser and is heated up. By accepted practice, this functionally parallel heat exchanger configuration in the present invention with two or more sub streams separately passing over the heat pump evaporator and condenser before remixing would not be expected to provide efficient or adequate net heating of the drying gas medium to drive the drying of the material in question in any reasonably economic way. This is because heat is both removed from and added to the sub-streams of the drying gas stream before they are remixed and the effects of this functionally parallel heating and cooling would be lost in most design configurations. However, it has been unexpectedly found that through judicious design of the associated evaporator and condenser heat exchangers and the flow of the drying gas sub-stream components as described in the invention, this configuration gives unexpectedly high energy and drying efficiency, very close to that achievable in a traditional series functional heat exchanger configuration while providing the increased quality benefits associated with a process where the drying gas flow is periodically reversed.

As with other existing heat pump systems, for low humidity operation, the drying capacity and efficiency of the invention can be optionally enhanced by recovering sensible cooling at the evaporator using a pair of liquid coupled or heat-pipe coupled heat exchangers at the evaporator (Blundell, 1979).

As those skilled in the art will appreciate, the process and apparatus of this invention will provide benefits to drying many different materials. These materials include but are not limited to timber, boards, paper, bricks, milk, gypsum, plaster board, textiles, china clay, fertilizer, dye stuffs, tiles, pottery, grain, nuts, seeds, fruits, bio-processing waste, etc.

The process and apparatus of this invention are also amenable to various drying gas mediums. Although the preferred embodiment for the invention is with air as the drying gas, the process and apparatus can be configured to use O2-free air, nitrogen, argon, oxygen, or any other gaseous medium to take up the moisture from the materials to be dried and condense that moisture out of the system through the heat pump evaporator as noted in (Chen, Bannister, McHugh, Carrington, Sun, 2000) for other more traditional heat pump drying systems. As with other existing heat pump systems, the invention requires means for rejecting excess heat from the kiln chamber. This may include full time or periodic venting of the drying gas, cooling the drying gas entering the evaporator, cooling any make-up or purge drying gas entering or leaving the apparatus, sub-cooling the liquid heat pump refrigerant leaving the condenser, cooling the heat pump refrigerant leaving the compressor, or cooling and partially or wholly condensing the high-pressure refrigerant for purposes of control.

Also, although the system is preferentially focussed on water removal, it can also be configured to remove other vaporisable and condensable liquids from the material to be dried such as various organic solvents to be recovered from solvent based processing steps including painting.

### BRIEF DESCRIPTION OF THE DRAWINGS

Preferred embodiments of the invention will be described with reference to the accompanying drawings, of which:

FIG. 1 shows a basic heat pump process flow diagram,

FIGS. 2A and B show preferred heat exchanger and drying chamber configurations in forward and reverse drying gas flow,

FIGS. 3A and B show the detail of the overall heat exchange configuration in forward and reverse drying gas flow,

FIG. 4 shows a heat pump process flow diagram with separate evaporator sections and multiple compression devices each arranged in functionally parallel configurations independent of airflow direction,

FIG. 5 shows a heat pump drying system with nominal flow in the forward direction with both a preferred overall heat pump condenser and evaporator configuration and a preferred variable evaporator area configuration,

FIG. 6 shows an example temperature profile during timber drying, and

FIG. 7 shows a graph comparing drying performance with respect to evenness of drying.

### DETAILED DESCRIPTION OF THE PREFERRED EMBODIMENTS

The present invention is a process and apparatus to improve the heat pump based or heat integrated drying of timber and other materials. A preferred embodiment of the invention involves conducting the heating and cooling/partial condensing of two sub-streams of drying gas flow by indirect heat exchange against the respective heat pump condenser and evaporator in functionally parallel sub-stream flow paths such that at least one sub stream exchanges heat with substantially only the heat pump evaporator and at least one other sub stream exchanges heat with substantially only the heat pump condenser with the ability to efficiently reverse the direction of drying gas flow through the corresponding heat exchangers. Another preferred embodiment of the invention involves conducting the cooling/partial condensing of one or more sub streams of drying gas flow by indirect heat exchange against the heat pump evaporator configured such that each of these sub streams is in a functionally parallel configuration and passes over different areas of the heat pump evaporator that may be active or inactive for heat exchange. The overall flow of refrigerant through the heat pump system is then controlled along with the active area for heat exchange in the evaporator to increase efficiency. In another preferred embodiment, this control along with control of the rate of heat rejected from the overall drying system is then preferably provided based on sensing the wet bulb and dry bulb temperatures of the drying gas stream such that the heat rejection rate is varied to keep the wet bulb temperature nominally constant for an extended period during the drying process while the flow of refrigerant through the heat pump and the active evaporator heat exchange area are varied to keep the dry bulb temperature within certain limits.

The following description of the process and apparatus of this invention, by way of example only and with reference to the accompanying drawings in the accompanying figures, indicates the presently preferred embodiments of the invention.

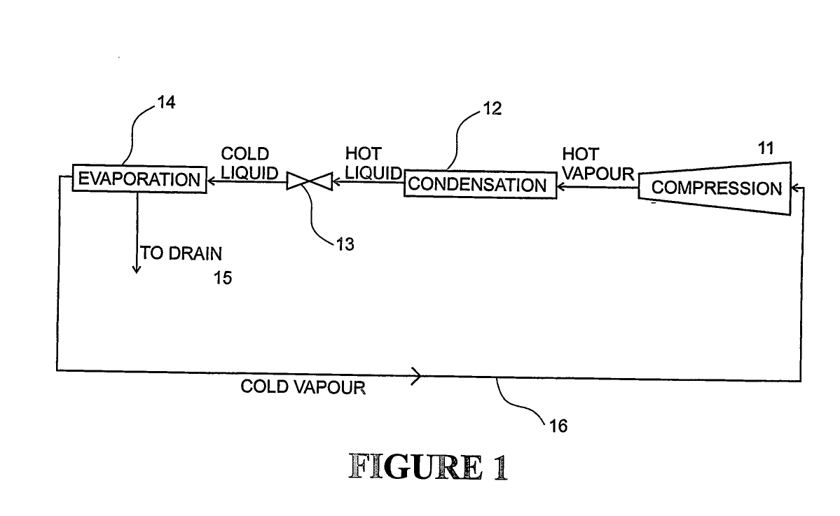

Referring to FIG. 1, the basic heat pump cycle is put forward with the primary sequence of processes for the refrigerant cycle of compression 11, condensation 12, expansion 13 and evaporation 14 with the drain 15 to indicate the removal of condensed liquid from the drying gas stream (not shown) at the evaporator 14 and stream 16 retuning to the compressor to indicate the closed loop nature of the refrigerant flow.

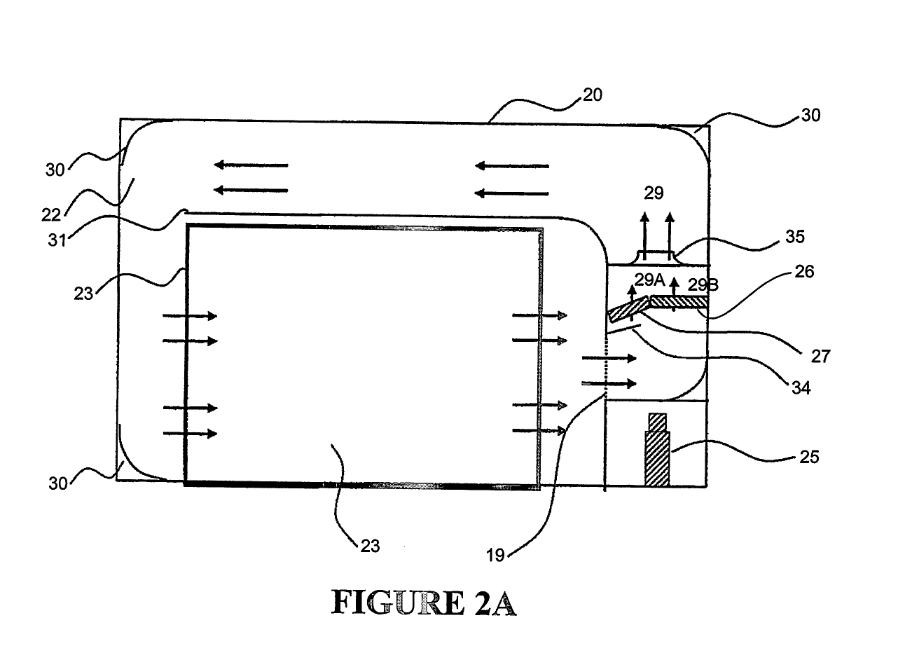

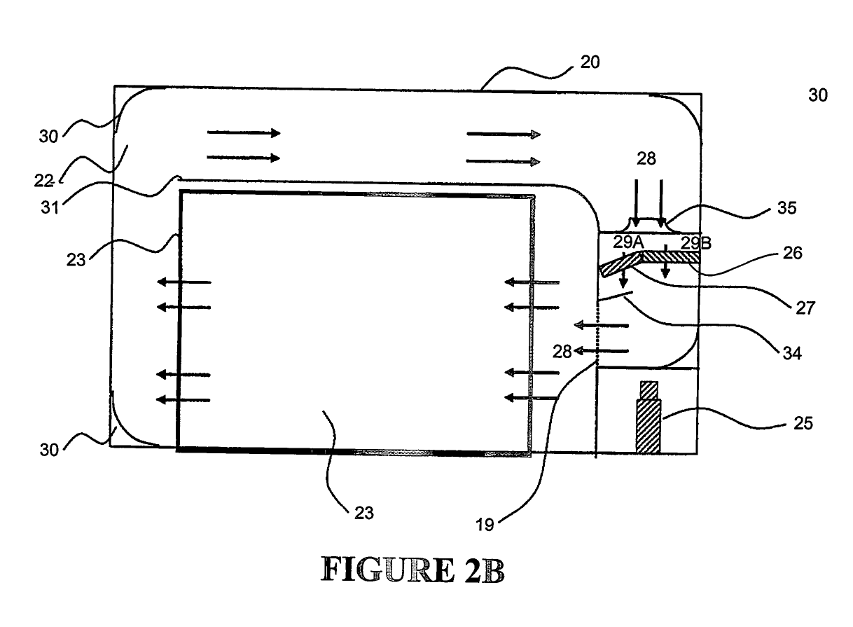

In the context of a dehumidifier drying system 20, referring to FIG. 2A, the heat pump compressor 25 operates to move heat from the lower temperature evaporator heat exchanger 27 to the higher temperature condenser heat exchanger 26. With these heat pump evaporator 27 and condenser 26 heat exchangers in a parallel configuration in the drying gas path 29, the part of the drying gas 29A passing over the evaporator heat exchanger 27 will lose heat, decrease in temperature and some of the moisture carried by that drying gas stream will condense while the part 29B of the drying gas passing over the condenser 26 heat exchanger will take up heat and increase in temperature. It is important to note that the functionally parallel configuration refers to the relationship between the heat exchangers 26, 27 and the drying gas flow 29, that is, the heat exchangers 26, 27 are arranged in functionally parallel configuration such that sub streams of the drying gas flow exchange heat substantially either with exchanger 26 or with exchanger 27. The term does not refer to the physical main geometric axis of the heat exchangers 26, 27 being in parallel with respect to each other. Heat pump operating parameters will be set such that the part of the drying gas that cools down in passing over the heat pump evaporator 27 heat exchanger will drop to a temperature below its dew point and some liquid will condense out of the vapour phase and be caught in drain 34 to be removed from the system.

After the drying gas has passed over the heat pump evaporator 27 or condenser 26 heat exchangers, each part of the drying gas 29A, 29B has an increased capacity to take up moisture. Upon mixing these two sub-streams (in this case with the fan system 35), the combined drying gas 29 will also have an increased capacity to take up moisture and thus provide the unexpectedly high efficiency of the overall drying process for this alternative configuration.

Considering the situation in which the drying gas flow 29 is in the anti-clockwise direction through the system in FIG. 2A, the two drying gas sub-streams 29A, 29B then pass through a reversible fan system 35 (or other mechanism for creating a drying gas flow) which provides the motive force to circulate the drying gas 29 through the overall system and acts to mix the two sub-streams 29A, 29B into a single nominally homogeneous drying gas stream 29. In the anti-clockwise flow direction, the single drying gas stream 29 is guided through the system superstructure 20 in the section of the superstructure 22 by various flow conditioning devices 30 which act to minimise pressure drop in the system. An additional device 31 is shown to guide the drying gas flow 29 around the system and through the material to be dried 23 in a single pass configuration. It should be apparent to those skilled in the art that this drying gas flow guide 31 could be configured in many various ways to achieve different paths for the drying gas 29 to flow through the material to be dried 23.

Once the drying gas has passed over and/or through the material 23 to be dried and picked up moisture evaporating from the material, it returns to the heat pump though partition 19 and continues to recirculate through the system. It can be appreciated by those skilled in the art that the drying gas flow need not be recirculated in a rigorously closed loop. It is readily possible within the scope of the invention to have various drying gas purge and makeup streams as is appropriate to the specific drying application.

In the reverse flow configuration shown in FIG. 2B, the process is fundamentally the same except the sequence of the gas flow cycle 28 proceeds in the clockwise direction. Reversal of airflow takes place at a suitable interval known to those skilled in the art to achieve even drying. (Keey, Langrish and Walker, 2000) Starting with the heat pump evaporator 27 and condenser 26 heat exchangers, the sub-streams 28A, 28B of drying gas passing over each respective exchanger 27 and 26, would then both pass through partition 19 which optionally could be configured to act as a mixing device to homogenise the two drying gas sub streams 28A, 28B. It is also possible to allow the turbulent flow of the gas to provide mixing of the drying gas sub streams as part of their flow through the process. As in the anti-clockwise case, the drying gas would have an increased capacity to take up moisture as it next passes over and/or through the material 23 to be dried where it takes up some moisture evaporating from the material. After passing over and/or through the material 23 to be dried, the drying gas then passes around the inside of the superstructure 20 in the section 22, aided by the flow conditioning devices and guides 31 and 30 before entering the reversible fan system 35. Upon exiting the reversible fan system 35, the drying gas then passes over the heat pump evaporator 27 and condenser 26 heat exchangers as two parallel sub streams 28A, 28B completing the clockwise cycle of flow and moisture removal in a functionally equivalent way to the anti-clockwise cycle of flow.

It can be appreciated by those skilled in the art that other waste heat sources or sinks may be available at low cost in certain process environments. In these situations, for the case where the heat pump system is augmented or replaced by an alternate high temperature heat source and lower temperature heat sink, the condensing duty from the heat pump refrigerant working fluid is augmented or replaced by the high temperature heat source in the heat exchange system and the evaporating duty from the heat pump refrigerant working fluid is augmented or replaced by the lower temperature heat sink in the heat exchange system.

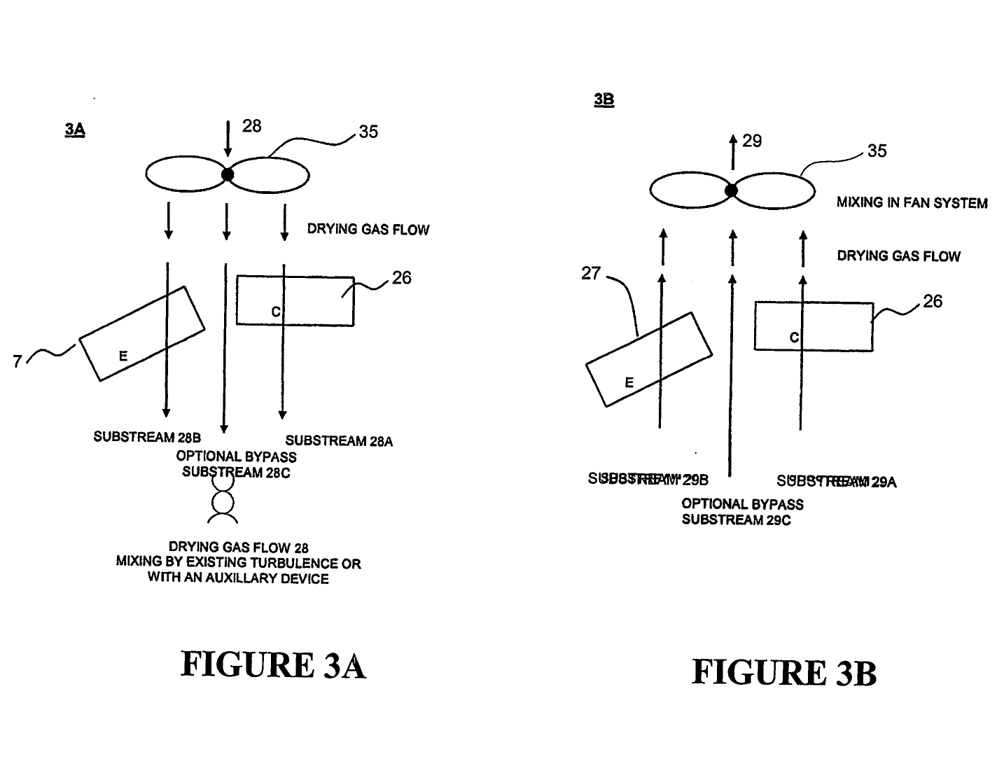

The detail of heat exchange configuration in forward and reverse drying gas flow shown in FIGS. 3A and 3B indicates how the drying gas contacts and transfers heat with the heat pump evaporator and condenser heat exchangers in a functionally parallel-gas-flow configuration. This functionally parallel-gas-flow configuration is best explained in the context of dividing the drying gas flow into two or more sub-streams 28A, 28B, 29A, 29B which exchange heat with either the condenser 26 (sub-stream A), the evaporator 27 (sub-stream B), or as is shown in the FIGS. 3A and 3B, with neither the evaporator nor the condenser as an optional bypass sub-stream C. It can be appreciated by those skilled in the art that a small sub-stream of drying gas could indeed exchange heat with both the evaporator 27 and the condenser 26 as an additional optional configuration not shown. In addition, the specific geometry of the exchangers shown can be altered through various angles, rotations or dislocations without materially changing the invention. The separation of the drying gas into these sub stream will result from the functionally parallel configuration of the heat exchangers 26 and 27 while the remixing will result from the gas moving device in one direction and either the natural turbulence of its flow or through the addition of an auxiliary device depending on the particular requirements for even mixing of the gas sub streams.

As described earlier in the context of FIGS. 2A and B when other waste heat sources or sinks are available at low cost in certain process environments, it is readily possible to use such high temperature heat sources to supplement or replace the condensing duty in heat exchanger C in FIGS. 3A and 3B. Similarly in such cases, it is readily possible to use such lower temperature heat sinks to supplement or replace the evaporating duty in heat exchanger E in FIGS. 3A and 3B

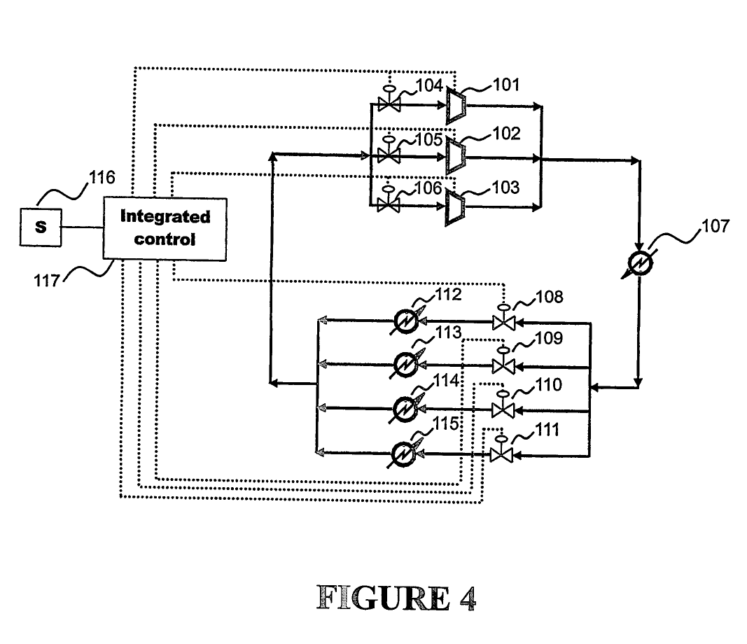

FIG. 4 is a simplified process flow diagram which illustrates further improvements which may be applied to a heat pump drier. Here the heat pump refrigerant is compressed from low pressure by a compression system designated by separate compressor modules 101, 102 and 103. The flow of refrigerant is controlled to each of these compressor modules by valves 104, 105 and 106 respectively. The control signal for these valves comes from an integrated control system 117 which in turn takes input from one or more sensors 116 in the refrigerant stream, the drying gas medium, the material being dried, and/or the moisture extracted from the drying material. A preferred embodiment of the invention specifically focuses on wet bulb and dry bulb temperature sensors in the drying gas stream although other options are not excluded. When any of the control valves 104, 105 or 106 are shut completely, the integrated control system will also signal the corresponding compressor module or modules to shut off to save power and improve the process efficiency. This configuration illustrates the example of control of the total refrigerant flow in the heat pump using a multi-compressor compression system and associated suction valves. This compression and refrigerant flow control will also correspondingly control the rate of heat movement between the evaporator and condenser of the heat pump system as well as the total power consumption by the heat pump system. It is also acknowledged that various other compression systems, such as a positive displacement compressor run by a variable speed drive, can also accomplish this efficient control of total refrigerant flow in the heat pump circuit as part of the present invention.

The high pressure refrigerant is then condensed in heat exchanger 107 which provides at least part of this heat of condensation to the drying gas stream. The condensed high pressure refrigerant then passes to two or more parallel evaporator heat exchange areas 112, 113, 114 and 115 through their respective expansion control valves 108, 109, 110 and 111. This arrangement results in a variable heat exchange area for evaporating refrigerant, sections of which can be activated and de-activated as required to alter the effective heat exchange area. In this manner, the variation in heat exchange area is such that sections of heat exchange area, in a functionally parallel configuration to each other relative to the drying gas medium, are put into and out of active heat exchange service with the drying gas medium. Note that the number of evaporation modules need not equal the number of compression modules nor is it required for there to be a one to one correspondence with said compressor modules although the general mode of operation will be such that the active evaporator area is typically decreased as the refrigerant flow through the overall heat pump circuit is reduced. It will be appreciated that the variable evaporator heat exchange total area could be constructed in a various ways. For example, the evaporator variable heat exchange area may be formed from one evaporator with multiple sections that can be activated or de-activated as required, or with multiple independent evaporators that can be independently activated or de-activated. Multiple independent evaporators may also each comprise multiple sections, each of which can be activated or de-activated.

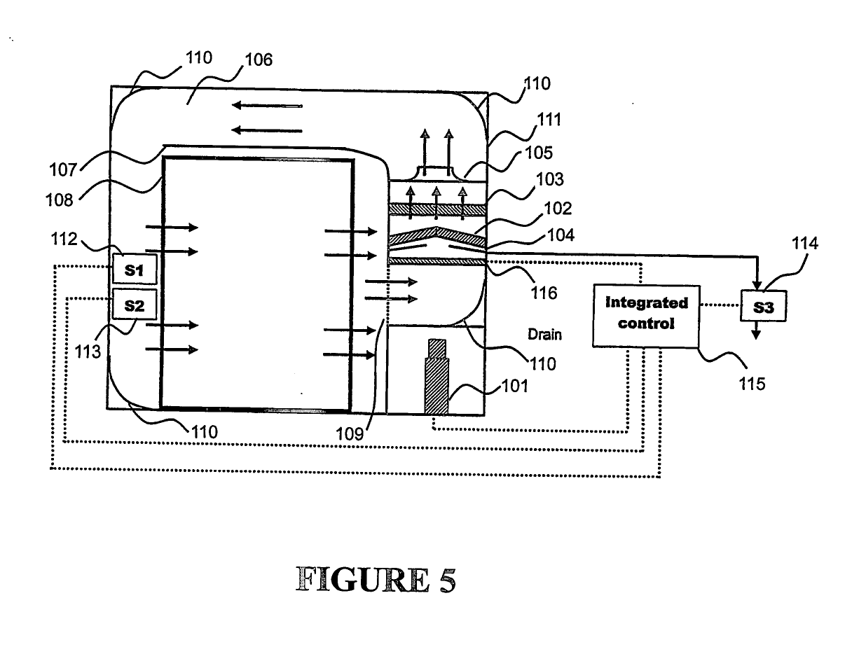

As for the compression system and the total flow of refrigerant in the heat pump circuit, the refrigerant flow through each of these evaporator heat exchange areas is controlled through integrated control system 117 which in turn takes input from the drying gas wet bulb and dry bulb temperature sensors 116. Although it is noted that other sensors in the refrigerant stream, the drying gas medium, the material being dried, and/or the moisture extracted from the drying material may optional be used. Each of these evaporator heat exchange areas is specifically positioned in a functionally parallel configuration to each other relative to the drying gas flow, described later in the context of FIG. 5, to remove at least some heat from the drying gas stream such that moisture from that drying gas stream is condensed out and removed from that drying gas stream. After passing through the evaporator heat exchanger system, the low pressure evaporated refrigerant returns to the compressor system in a standard recirculation flow configuration.

Referring to the simplified heat pump drier configuration diagram in FIG. 5 with the drying gas flowing through the drier in an anti-clockwise direction, the heat pump compressor system 201 operates to move heat from the lower temperature parallel evaporator heat exchangers 202A, B, and C to the higher temperature condenser heat exchanger 203. Any excess heat is removed from the drying gas for control purposes through exchanger 216. Although it is shown upstream of the heat pump condenser and evaporator in the anti-clockwise flow direction in this figure, it will be understood by those skilled in the art that there are numerous other locations possible for an exchanger to remove such excess heat for control purposes.

As the drying gas passes over the evaporator heat exchangers it will lose heat and decrease in temperature and as the drying gas passes over the condenser heat exchanger it will take up heat and increase in temperature. Heat pump integrated control parameters will be set such that as the drying gas that cools down in passing over the heat pump evaporator heat exchangers it will drop to a temperature below its dew point and some liquid will condense out of the vapour phase and be caught in drain 204 to be removed from the system. It is important to note that the evaporator heat exchange area under control is specifically configured such that when only part of the evaporator heat exchange area is active, the drying gas flow will continue over the inactive heat exchange area without coming into thermal contact with the active area. This specifically allows the heat removal by the evaporator to be concentrated over a fraction of the drying gas flow so that sufficient liquid will condense from that part of the drying gas stream to continue the drying process. This configuration can be considered as dividing the drying gas flow into two or more sub streams which then either pass over the heat pump condenser heat exchanger and are heated or pass over the heat pump evaporator exchanger and are cooled and the moisture carried by that sub stream is partially condensed and drained from the system.

The part of the drying gas that passes over the heat pump condenser exchanger 203 where is heated and combined with the part of the drying gas that passed over the heat pump evaporator and with any other sub streams of drying gas that may have been optionally split out before passing through a fan system 205 which provides the motive force to circulate the drying gas through the overall system. The drying gas stream is then guided through the system superstructure 211 in the section of the superstructure 206 by various flow conditioning devices 210 which act to minimise pressure drop in the system. An additional device 207 is shown to guide the drying gas flow around the system and through the material to be dried 208 in a single pass configuration. It should be apparent to those skilled in the art that this drying gas flow guide 207 could be configured in many various ways to achieve different paths for the drying gas to flow through the material to be dried 208.

Once the drying gas has passed over and/or through the material to be dried 208 and picked up moisture evaporating from the material, it returns to the heat pump though partition 209. The evaporator configuration, the corresponding refrigerant flow control and the drying gas flow arrangement may or may not be combined with reverse flow capabilities depending on the requirements and limitations of a particular application.

Although there are many possible ways to provide control for this process and apparatus, a preferred embodiment of the invention is to control the heat pump and the drying process in concert through rejecting heat from the process using input from the drying gas dry bulb and wet bulb temperature sensors and optionally the amount of total liquid removed from the system such that the wet bulb temperature is kept constant through the main drying period while the dry bulb temperature increases to provide the optimum driving force for moisture extraction from the material being dried as measured by the amount of liquid removed from the system through the drain line or the difference between the wet and dry bulb temperatures within the limits of the heat pump system capabilities. Then when the drying process has progressed to the point where the drying gas dry bulb temperature reaches a maximum value based on the limits of the heat pump compressor system, the control adjusts the total refrigerant flow through the compression system down while keeping the drying gas wet bulb temperature largely constant.

The specific hierarchy of control in this preferred embodiment initially runs the process at the maximum drying capacity and rate of heat rejection. To maintain the overall stability of the process and heat pump operation at the highest drying rate and most efficient heat pump conditions, the preferred embodiment then increases the dry bulb temperature as the drying progresses while maintaining the wet bulb temperature roughly constant. Then when the dry bulb temperature reaches a predetermined maximum, the heat pump refrigerant flow is reduced to limit the further rise in dry bulb temperature and reduce the power consumption of the heat pump. As this maximum is approached, the wet bulb temperature may then optionally be varied to limit the overall driving force for drying the material to prevent internal stresses from damaging the material being dried based on a combination of the difference between the wet and dry bulb temperatures and the rate of overall moisture extraction from the system.

This new control scheme has the benefit of keeping the evaporating and condensing temperatures within the allowed ranges for the heat pump compressor system as well as driving the heat pump system and the drying process at their maximum efficient states according to the natural drying rate reduction as the drying process progresses This comes out of increasing the drying gas dry bulb temperature at a substantially constant rate of dehumidification in order to increase the driving force for drying, while maintaining a slower variation in the wet bulb temperature over the length of the drying process to smoothly remain within the compressor operating limits and properly manage the stresses present in the material being dried, as the inherent drying rate naturally drops off as the drying process progresses. Thus in response to the falling drying rate of the material being dried, the new control system automatically increases the drying force applied to the product in order to substantially maintain the drying rate. Because the adjustment in the drying force can be linked to the moisture content of the product, the driving force can be controlled to ensure it is consistent with the capacity of the material to tolerate the progressively more aggressive drying conditions. The result is that the maximum drying rate is maintained longer than with the prior art, and the drying end-point is achieved more quickly while avoiding drying conditions that could damage the product.

It is important to note that although the temperature sensors have been shown in FIG. 5 where the drying gas enters the material drying chamber, there are numerous other functionally equivalent locations where the temperature sensors can be located in the drying gas flow stream without materially changing the invention. Furthermore, additional system protection sensors can also be included in the heat pump refrigeration circuit without materially changing the invention but they would not provide primary operational control for the process in the preferred embodiment.

Thus, the performance of the drier can be optimised during the start of the drying process to ensure the heat pump is highly loaded when the dry bulb temperature is lowest, and the humidity highest using a high refrigerant flow in the heat pump. The preferred embodiment will also control the drier to maintain the maximum possible drying rate as long as possible. Then, when it is no longer possible to maintain the maximum drying rate because of drying material stress and transport limitations, the control will manage the heat pump so that it operates effectively and efficiently at higher dry bulb temperatures and lower humidity under lower loads, as required to complete the drying process as fast and efficiently as possible using a lower refrigerant flow and higher active condenser area per unit refrigerant flow. This control will also maximise heat transfer at the condenser to enable the higher dry bulb temperatures for the drying gas flow to be achieved more efficiently. Furthermore, all of this is accomplished without disrupting the drying gas flow or negatively affecting the pressure drop in the drying gas circuit.

It can also be appreciated by those skilled in the art, that additional components specific to the product being dried, such as auxiliary heaters for sterilization, and water spray systems for reconditioning can be readily added to the process and apparatus of the invention without materially changing the invention.

Similarly there are various methods and apparatus that can be added to the process and apparatus of this invention to reject excess heat from the overall process to the ambient environment without materially changing the invention as is shown for example only by item 216 in FIG. 5. These include but are not limited to venting a sub-stream of drying gas, pre-cooling the drying gas entering the evaporator, cooling any make-up or purge drying gas entering or leaving the heat pump apparatus, sub-cooling the liquid heat pump refrigerant, de-superheating the heat pump refrigerant leaving the compressor, or partially or wholly condensing the high-pressure refrigerant for purposes of control.

As with other heat pump systems, additional methods of heat recovery may be optionally applied to the invention without material change to the invention. For instance, it is possible to include the capacity for reclaiming sensible cooling at the evaporator using, for example, either a pair of liquid coupled heat exchangers, or by means of heat-pipe coupled heat exchangers.

Also, it is within the scope of this invention to include auxiliary heat sources and sinks separate from the heat pump circuit to enhance and augment the heating of the drying gas by the heat pump condenser and the cooling and partial condensation of the drying gas by the heat pump evaporator without materially altering the invention itself.

As those skilled in the art will appreciate, the process and apparatus of this invention will provide benefits to drying many different materials. These materials include but are not limited to timber, boards, paper, bricks, milk, gypsum, plaster board, textiles, china clay, fertilizer, dye stuffs, tiles, pottery, grain, nuts, seeds, fruits, bio-processing waste, etc.

The process and apparatus of this invention are also amenable to various drying gas mediums. Although the preferred embodiment for the invention is with air as the drying gas, the process and apparatus can be configured to use O2-free air, nitrogen, argon, oxygen, or any other gaseous medium to take up the moisture from the materials to be dried and condense that moisture out of the system through the heat pump evaporator. As with other existing heat pump systems, the invention requires means for rejecting excess heat from the kiln chamber. This may include desuperheating, condensing or sub-cooling refrigerant leaving the compressor and rejecting heat to the environment. Alternatively the drying gas may be precooled as it enters the evaporator or the dehumidifier more generally.

Also, although the system is preferentially focussed on water removal, it can also be configured to remove other vaporisable and condensable liquids from the material to be dried such as various organic solvents to be recovered from solvent based processing steps including painting.

Although the Figures show preferred embodiments for timber processing, it can readily be appreciated that minor changes to the drying chamber configuration can be made to facilitate the drying of other materials, in other drying gas mediums and for removing liquids other than water.

In the preferred embodiments for timber drying for a typical charge of green timber with 150% moisture content to start and drying to a 10% moisture content before any optional spray reconditioning, the nominal conditions are summarised in Table 1:

TABLE 1

| Timber Drying Example Parameter | Range | |
|---|---|---|
| Dry bulb temperature of drying gas | 35-70 | C. |
| (average over the system) | | |
| Wet bulb temperature of drying gas | 20-65 | C. |
| (average over the system) | | |
| Drying gas velocity through drying product | 2-5 | m/s |
| Approach temperature in heat pump condenser | 2-25 | C. |
| Approach temperature in heat pump evaporator | 2-45 | C. |
| Drying gas temperature rise across condenser heat | 3-15 | C. |
| exchanger | | |
| Drying gas temperature drop across evaporator heat | 3-35 | C. |
| exchanger | | |
| Condenser temperature heat pump fluid side | 40-85 | C. |
| Evaporator temperature heat pump fluid side | 20-65 | C. |

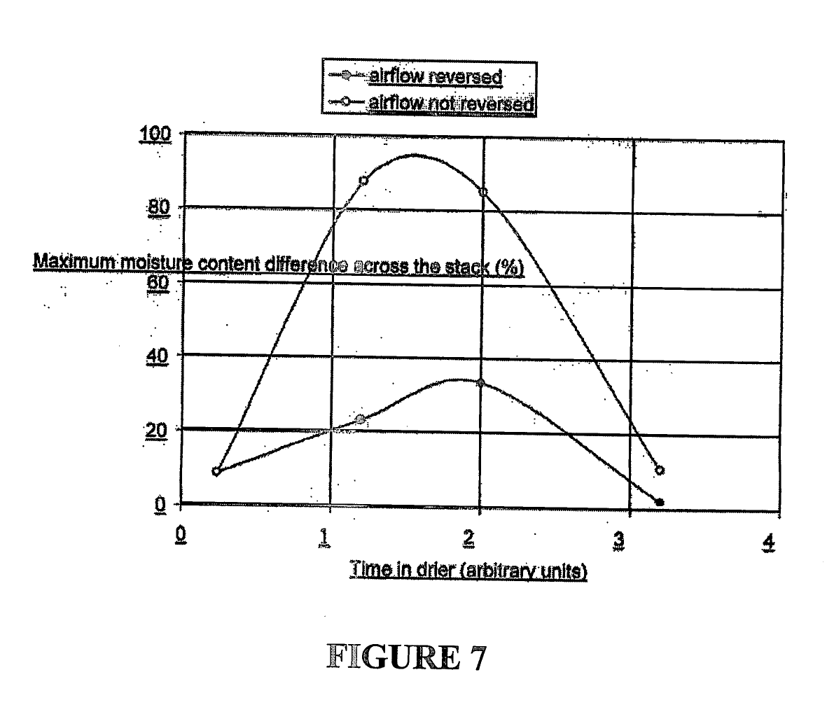

For lumber drying in conventional heat-and-vent kilns, air flow reversal reduces the variation in the moisture content of boards along the direction of air flow within the timber stack (Keey, Langrish, Walker, 2000). An example of how the current invention achieves this benefit this is shown in FIG. 7 which illustrates how the maximum difference in the moisture content of different boards in a stack of Pinus radiata would be expected to vary with time for a dehumidifier kiln based on detailed computational modelling. In this calculation example, reversals are carried out at intervals of 12 hours. Comparison of the two curves in the figure shows that the variation in moisture content is smaller when air flow is reversed in this way than when the air flow is unidirectional. This also shows that a given target range of moisture content can be achieved more quickly under an air flow reversal regime than under unidirectional air flow. Thus the reverse flow aspect of the invention achieves a performance benefit relative to the prior art heat pump drying systems.

The performance of the variable active evaporator and corresponding refrigerant flow control aspect of this invention is also expected to be superior to the existing technology based on the following arguments. With a conventional monolithic evaporator the compressor capacity can be turned down when the drying rate of the product falls, but there is a danger that the evaporating temperature of the refrigerant will exceed the allowed limits, since the evaporator is oversized relative to the low refrigerant flow and the refrigerant will be heated to a higher temperature in the exchanger. Consequently, it is necessary to ensure that the refrigerant temperature does not exceed preset limits under these conditions which will limit how far the compressor can be turned down to improve the drying efficiency during the later parts of the drying process. The alternative with the existing technology is to cycle the heat pump on/off when the drying rate falls. This is unsatisfactory, since it shortens the operating life of the heat pump. In addition, the drying gas temperature is still limited by the normal limits for the evaporating and condensing temperatures. In timber drying this means that the finishing stages of the drying process normally must be completed at temperatures of 50-55° C. which limits the driving force for moisture removal from the timber being dried.

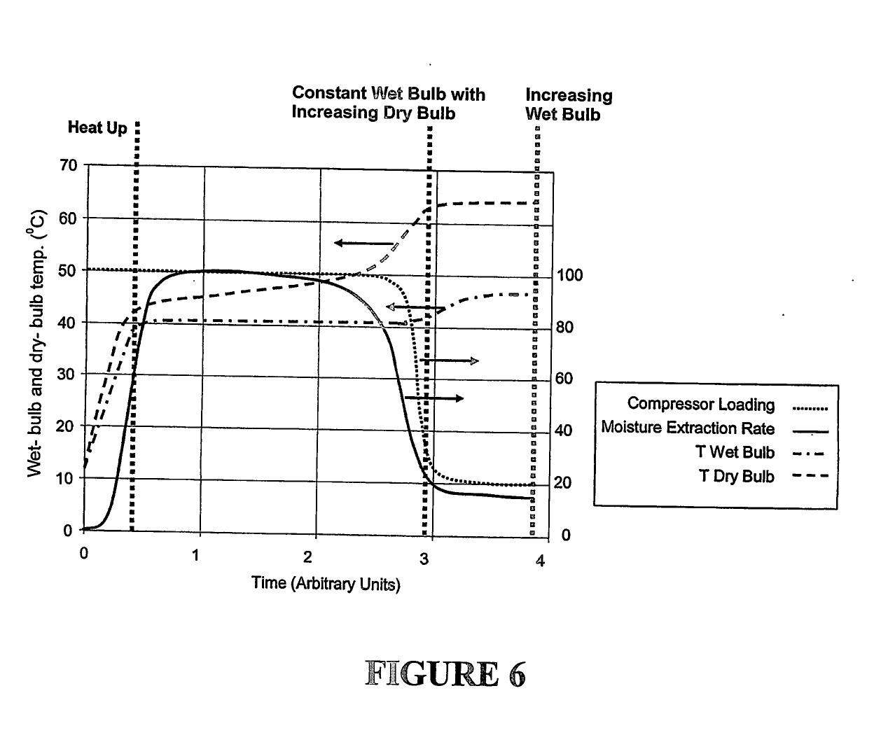

With the present invention considering the case of a system nominally comparable to the existing technology described in the previous paragraph using three stages of capacity reduction at the compressor and evaporator segments of the heat pump cycle and a constant condenser heat exchange area, detailed computer simulation has shown that the drying gas temperature can be increased progressively to 60-65° C. as the drying rate naturally falls. This gives a higher driving force for moisture removal from the timber during the later phase of the drying process, as illustrated in FIG. 6. As a consequence of this higher driving force for moisture removal, (60-65° C. vs. the 50-55° C. of the existing technology) the final stages of the drying process can be significantly accelerated, reducing the drying time by typically 20%-30% according to these detailed computer simulations.

The performance of the control component of invention is expected to be superior to the existing technology based on the following arguments. The proposed control strategy allows the dehumidifier to operate at its maximum potential capacity throughout the entire drying cycle by using the wet-bulb temperature as the primary measured variable for controlling the rate of heat rejection. Normally with existing control systems, the rate of heat rejection in heat pump drying kilns is controlled to maintain a given dry-bulb temperature. However with that form of control the dehumidifier capacity undergoes large changes in capacity as the relative humidity varies during the drying process. For dehumidifier dryers the drying capacity typically increases by 7% for 1° C. increase in the wet-bulb temperature with a fixed dry-bulb temperature. It decreases by less than 3% for 1° C. increase in dry-bulb temperature, at a fixed wet-bulb temperature.

In effect the system is approximately 2.3 times more sensitive to the wet-bulb setting than the dry-bulb. This is why it makes more sense to adjust the heat rejection to maintain the wet-bulb rather than the dry-bulb, provided both are within acceptable limits.

When the rate of heat rejection is controlled by measuring and maintaining the wet-bulb temperature, the dry-bulb temperature rises as the product dries. This is normally acceptable for the product, and is consistent with many accepted heat-and-vent drying schedules. In effect the natural drying trajectory of the heat pump dehumidifier kiln system which uses the wet bulb as the primary measured control variable is already close to accepted schedules, and this proposed invention makes use of this feature. Eventually the dry bulb temperature will reach the safe limit for the product being dried, or the dehumidifier will reach the normal operating limits for the condensing temperature of the compressors. As the limit temperatures are reached as indicated by the drying gas dry bulb temperatures with optional confirmation from the refrigeration circuit sensors, the heat pump refrigerant flow is reduced by reducing the compressor capacity. Rather than using the measured refrigerant pressure to specify the limit conditions, this scheme uses the dry-bulb temperature as an indicator. This is cheaper to do, and it integrates well with the overall drying cycle control.

A preferred example of the function of the control system based on detailed computer process simulation is shown in FIG. 6. The wet and dry bulb temperatures start at an ambient of roughly 12° C. as read from the left side of the graph and the drying run begins with a “Heat Up” phase. It is acknowledged that additional auxiliary heaters may be used to accelerate this phase without materially affecting the invention. When the system reaches the preset wet bulb temperature, in this case 41° C., the control system acts to run the heat pump to extract the maximum rate of moisture removal and run the heat rejection coil to maintain that wet bulb temperature through adjusting the amount of heat rejected from the system. Detailed computer simulation has shown that the drying gas temperature can be increased progressively to 60-65° C. as the drying rate naturally falls within the limits of commonly available compressors as shown in the “Constant Wet Bulb with Increasing Dry Bulb” phase in FIG. 6. This gives a higher driving force for moisture removal from the timber during the later parts of the drying process, as indicated by the difference between the wet and dry bulb also illustrated in FIG. 6. This is also reflected in the ability of the control system to keep the moisture extraction rate closer to its maximum value for longer as measured on the right side of the graph. In cases where the driving force must be moderated because of limits present in the material being dried, the wet bulb temperature can be increased to control the driving force within these material based limits as shown in the “Increasing Wet Bulb” phase in FIG. 6.

It will be appreciated that the invention is not restricted to the particular embodiments and modifications described above and that numerous modifications and variations can be made without departing from the scope of the invention.

### REFERENCES CITED

U.S. Pat. No. 2,332,981 26 Oct. 1943 Anderson
U.S. Pat. No. 2,418,239 1 Apr. 1947 Smith
U.S. Pat. No. 4,182,048 8 Jan. 1980 Wolfe and Hinton
U.S. Pat. No. 4,250,629 17 Feb. 1981 Lewis
U.S. Pat. No. 4,356,641 2 Nov. 1982 Rosenau
NZ 213728 7 Oct. 1985 Thompson
U.S. Pat. No. 4,596,123 24 Jun. 1986 Cooperman
U.S. Pat. No. 4,599,808 15 Jul. 1986 Gelineau and Kinney
U.S. Pat. No. 5,138,773 18 Aug. 1992 Goodwin and Hogue
U.S. Pat. No. 5,253,482 19 Oct. 1993 Murway
U.S. Pat. No. 5,276,980 11 Jan. 1994 Carter and Sprague
U.S. Pat. No. 5,595,000 21 Jan. 1997 Goodwin
U.S. Pat. No. 5,940,984 24 Aug. 1999 Moren and Ab
U.S. Pat. No. 6,021,644 8 Feb. 2000 Ares and Lakdawala
U.S. Pat. No. 6,138,911 31 Oct. 2000 Cooper and Rawhouser
U.S. Pat. No. 6,209,223 3 Apr. 2001 Dinh
Bannister, P., Carington, G., Chen, G., Heat Pump Dehumidifier Drying Technology—Status, Potential and Prospects, Proceedings 7th International Energy Agency Conference on Heat Pumping Technology, May 19-22 2002, Beijing, China, Volume 1. China Architecture and Building Press, pp 219-230 (2002).
Bannister, P., Chen, G., Grey, A., Carrington, C. G. and Sun, Z. Econonic Reduction of Greenhouse Gas Emissions through Enhanced Dehumidifier Timber Drying. Refrigeration, Science and Technology, Proceedings Commission E2 with E1 and B2: Heat Pump Systems, Energy Efficiency and Global Warming, Linz, Austria. International Institute of Refrigeration, Paris. 241-249 (1997)
Bansal, B., Bannister, P., Carrington, C. G. Performance of a geared dehumidifier. International Journal of Energy Research. 21: 1257-1260 (1997)
Blundell C. J. Energy conservation using improved heat pump dehumidifiers, Electricity Council Research Establishment, Capenhurst, UK. Published report presented at 2nd International CIB Symposium on Energy Conservation in the Built Environment, Copenhagen (1979).
Carrington, C. G., Bannister, P, Bansal, B., Sun, Z. Design of medium temperature dehumidifier systems. In proceedings 19th International Congress of Refrigeration, Vol IIIb. The Hague, The Netherlands. International Institute of Refrigeration. 931-938 (1995)
Chen, G., Bannister, P., McHugh, J., Carrington, C. G., Sun, Z. F. Design of Controlled Atmosphere Dehumidifier Fruit Driers. IPENZ Transactions, (Institution of Professional Engineers New Zealand) 27: 31-34 (2000)
Chrusciel, L., Mougel, E., Zoulalian, A. A. New Air Dehydration Process for Wood Dryers. Part 1. Kinetic and Quality Drying of Wood. Holzforschung, 54: 201-206 (2000)
Keey, R. B., Langrish, T. A G., Walker, J. C. F. Kiln-Drying of Lumber. Springer, Berlin, Heidelberg (2000).
Kreber, B., Haslett, A. N., McDonald, A. G. Kiln Brown Stain in Radiata Pine: A Short Review on Cause and Methods for Prevention. Forest products Journal, 49: 66-70 (1999).

1. A heat exchange system for a drying apparatus, including:
a heat sink heat exchanger to cool and condense liquid out of a drying gas, with
a heat transfer surface arranged to exchange heat with a first sub-stream of the drying gas, and
a heat source heat exchanger to heat the drying gas, with a heat transfer surface arranged to exchange heat with a second sub-stream of the drying gas, and arranged in a functionally parallel configuration with said heat sink heat exchanger so that each of said drying gas sub-streams exchanges heat with one of the two said heat transfer surfaces per cycle through the heat exchange system, and
a gas movement device for propelling the drying gas through or around the heat sink and heat source heat exchangers in either a forward or a reverse flow path direction.

2. A heat exchange system according to claim 1 where at least part of the heat source heat exchanger is a condenser in a heat pump system.

3. A heat exchange system according to claim 2 where at least part of the heat sink heat exchanger is an evaporator in the heat pump system.

4. A heat exchange system according to any one of claims 1 to 3 arranged to heat the drying gas to a temperature between 25 and 90C.

5. A heat exchange system according to claim 3 wherein said gas movement device is a fan.

6. A heat exchange system according to any one of claims 1 to 5 including a gas flow path arranged to substantially mix the two gas streams after they have passed through or around said heat sink and heat source heat exchangers.

7. A heat exchange system according to any one of claims 1 to 6 including a control system arranged to reverse the drying gas flow direction based on any one or more of drying time, moisture content, wet or dry bulb temperature or relative humidity of the drying gas, or integrated amount of moisture removed from the drying gas.

8. A heat exchange system according to claim 7 including sensor(s) for determining the dry-bulb and wet-bulb temperatures and/or relative humidity for the drying gas flow entering and/or leaving the dehumidifier.

9. A heat exchange system according to either one of claims 7 and 8 wherein said control system is arranged to be able to reduce power consumption of the heat exchanger system during drying by reducing the capacity of the heat sink heat exchanger to condense moisture out of the drying gas and/or the capacity of the heat source exchanger to heat the drying gas.

10. A heat exchange system according to any one of claims 1 to 9 including means for rejecting heat from the drying apparatus to the external environment

11. A heat sink exchange system according to any one of claims 1 to 10 arranged so that the drying gas passes over a substantially closed loop path repeatedly through the heat exchange system and past or through a drying chamber for containing a material to be dried.

12. A drying apparatus including:
a chamber for material to be dried,
a gas movement device for propelling a drying gas in alternative forward and reverse flow path directions through the chamber,
a heat exchanger to cool and condense liquid out of the drying gas, with a heat transfer surface to exchange heat with a first sub-stream of the drying gas, and
a heat exchanger to heat the drying gas, with a heat transfer surface to exchange heat with a second sub-stream of the drying gas,
said heat transfer surfaces being arranged so that the said drying gas sub-streams will exchange heat with at most one of the two said heat transfer surfaces per cycle through the said heat exchangers.

13. A heat pump for a drying apparatus including:
a gas movement device for propelling a drying gas in alternative reverse flow path directions,
an evaporator to cool and condense liquid out of the drying gas, with a heat transfer surface arranged to exchange heat with a first sub-stream of the drying gas, and
a condenser to heat the drying gas, with a heat transfer surface arranged to exchange heat with a second sub-stream of the drying gas, and, such that at least part but less than a majority of the flow in the said drying gas sub-streams will exchange heat with both the evaporator and condenser in each cycle through the heat pump.

14. A heat exchange apparatus operable in a drying apparatus with reversible drying gas flow including a cold heat exchanger and a hot heat exchanger arranged such that during operation the heat exchangers lie in a functionally parallel configuration relative to the drying gas flow, whereby a first sub-stream of the drying gas flow substantially exchanges heat with only the cold heat exchanger, and a second sub stream of the drying gas flow substantially exchanges heat with only the hot heat exchanger.

15. A heat exchange system according to any one of claims 1 to 14 wherein said heat sink heat exchanger contains a heat sink medium to cool and condense liquid out of the drying gas, with a heat sink heat transfer surface comprising two or more sections connected in a functionally parallel configuration with each other arranged to exchange heat with two or more substreams of the drying gas so that each drying gas sub-stream exchanges heat with no more than one of the two or more said heat sink heat transfer surface sections per cycle through the heat exchange system.

16. A heat exchange system according to claim 15 with a control system arranged to control the flow of heat sink medium in the heat sink heat exchanger sections and increase, decrease, turn on, and/or turn off the flow of heat exchange medium independently in each of the heat sink heat exchanger sections.

17. A heat exchange system for a drying apparatus including:
a drying gas to remove moisture from the material being dried, and
a heat source heat exchanger containing a heat source medium to heat the drying gas, and
a heat sink heat exchanger containing a heat sink medium to cool and condense liquid out of a drying gas, with a heat sink heat transfer surface comprising two or more sections connected in a functionally parallel configuration with each other arranged to exchange heat with two or more substreams of the drying gas so that each drying gas sub-stream exchanges heat with no more than one of the two or more said heat sink heat transfer surface sections per cycle through the heat exchange system.

18. A heat exchange system according to claim 17 with a control system to control the flow of heat sink medium in the heat sink heat exchanger sections and increase, decrease, turn on, and/or turn off the flow of heat exchange medium independently in each of the heat sink heat exchanger sections.

19. A heat exchange system according to claim 17 or 18 where at least part of the heat sink heat exchanger is an evaporator in a heat pump system.

20. A heat exchange system according to claim 19 where at least part of the heat source heat exchanger is a condenser in a heat pump system.

21. A heat exchange system according to any one of claims 17 to 20 arranged to heat the drying gas to a temperature between 25 and 90C.

22. A heat exchange system according to any one of claims 17 to 21 including a drying gas flow path arranged to substantially mix the two or more of the said drying gas sub streams after they have passed through or around said heat sink heat exchanger sections.

23. A heat exchange system according to any one of claims 17 to 22 including sensor(s) for determining the dry-bulb and wet-bulb temperatures, relative humidity for the drying gas flow entering and/or leaving the dehumidifier, drying time and/or other indicator or indicators such as heat sink or source fluid temperature or pressure, moisture content of the material being dried, drying rate, or integrated amount of moisture removed from the system.

24. A heat exchange system according to any one of claims 17 to 23 wherein said control system is arranged to be able to temporarily reduce during drying, the overall capacity of the heat sink heat exchanger to condense moisture out of the drying gas and the overall capacity of the heat source exchanger to heat the drying gas.

25. A heat exchange system according to any one of claims 17 to 24 including means for rejecting heat from the drying apparatus to the external environment such as full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, or partially or wholly condensing the high-pressure refrigerant for purposes of control.

26. A heat sink exchange system according to any one of claims 17 to 25 arranged so that the drying gas passes over a substantially closed loop path repeatedly through the heat exchange system and past or through a drying chamber for containing a material to be dried.

27. A drying apparatus including:
a chamber for material to be dried,
a drying gas to remove moisture from the material being dried, and
a heat source heat exchanger containing a heat source medium to heat the drying gas, and
a heat sink heat exchanger containing a heat sink medium to cool and condense liquid out of a drying gas, with a heat sink heat transfer surface comprising two or more sections connected in a functionally parallel configuration with each other arranged to exchange heat with two or more substreams of the drying gas so that each drying gas sub-stream exchanges heat with one of the two or more said heat sink heat transfer surface sections per cycle through the heat exchange system.

28. A heat pump for a drying apparatus including:
a condenser to heat the drying gas, and
an evaporator to cool and condense liquid out of a drying gas, with a heat transfer surface comprising two or more sections connected in a functionally parallel configuration with each other arranged to exchange heat with two or more substreams of the drying gas so that each drying gas sub-stream exchanges heat with no more than one of the two or more said evaporator heat transfer surface sections per cycle through the heat pump.

29. A heat exchange apparatus operable in a drying apparatus including a hot heat exchanger and a cold heat exchanger with two or more segments arranged such that during operation the segments of the cold heat exchanger lie in a functionally parallel configuration relative to the drying gas flow, whereby two or more sub-streams of the drying gas flow substantially exchanges heat with no more than one of the cold heat exchanger sections per pass through the apparatus.

30. A heat exchange system according to any one of claims 1 to 14 and 17 to 26 which is part of a heat pump and wherein said heat source heat exchanger comprises
a means to evaporate the heat pump refrigerant in which at least a portion of the heat of evaporation of the refrigerant is transferred by heat exchange from a drying gas medium, and
said heat sink heat exchanger comprises a means to condense the heat pump refrigerant after it has been compressed in which at least a portion of the heat of condensation is transferred by heat exchange to a drying gas medium, and wherein said heat pump includes a means for sensing the wet bulb and dry bulb temperatures of the drying gas,
a means for rejecting heat from the drying apparatus,
a means for controlling the amount of heat rejected from the drying apparatus based on the wet bulb temperature of the drying gas such that the wet bulb temperature is kept nominally constant for an extended period during the drying process, and
a means for controlling the total flow of refrigerant in the heat pump circuit based on the dry bulb temperature of the drying gas such that the dry bulb temperature is kept within certain limits throughout the drying process.

31. A heat exchange system according to claim 30 where the means for rejecting heat from the drier to the external environment involves full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, and/or partially or wholly condensing the high-pressure refrigerant.

32. A heat exchange system according to either of claims 30 to 31 with said control means for changing the rate of heat rejection from the drier based on drying time and/or other indicator or indicators such as refrigerant temperature or pressure, moisture content of the material being dried, drying rate, wet or dry bulb temperature and/or relative humidity of the drying gas, or integrated amount of moisture removed.

33. A heat exchange system according to any one of claims 30 to 32 with said control means for changing the total system refrigerant flow based on drying time and/or other indicator or indicators such as refrigerant temperature or pressure, moisture content of the material being dried, drying rate, wet or dry bulb temperature and/or relative humidity of the drying gas, or integrated amount of moisture removed.

34. A heat exchange system according to claim 33 where the refrigerant flow control means involves reducing or increasing the heat pump compressor capacity or turning one or more heat pump compressors on or off.

35. A heat pump for a drying apparatus including:
a means to evaporate the heat pump refrigerant in which at least a portion of the heat of evaporation of the refrigerant is transferred by heat exchange from a drying gas medium, and
a means to condense the heat pump refrigerant after it has been compressed in which at least a portion of the heat of condensation is transferred by heat exchange to a drying gas medium, and
a means for sensing the wet bulb and dry bulb temperatures of the drying gas, and
a means for rejecting heat from the drying apparatus, and
a means for controlling the amount of heat rejected from the drying apparatus based on the wet bulb temperature of the drying gas such that the wet bulb temperature is kept nominally constant for an extended period during the drying process, and
a means for controlling the total flow of refrigerant in the heat pump circuit based on the dry bulb temperature of the drying gas such that the dry bulb temperature is kept within certain limits throughout the drying process.

36. An apparatus according to claim 35 where the means for rejecting heat from the drier to the external environment involves full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, and/or partially or wholly condensing the high-pressure refrigerant.

37. An apparatus according to claim 35 or 36 operating with drying gas temperatures between 25 and 90C.

38. An apparatus according to any one of claims 35 to 37 using air as the drying gas.

39. An apparatus according to any one of claims 35 to 38 with said control means for changing the rate of heat rejection from the drier based on drying time and/or other indicator or indicators such as refrigerant temperature or pressure, moisture content of the material being dried, drying rate, wet or dry bulb temperature and/or relative humidity of the drying gas, or integrated amount of moisture removed.

40. An apparatus according to any one of claims 35 to 39 with said control means for changing the total system refrigerant flow based on drying time and/or other indicator or indicators such as refrigerant temperature or pressure, moisture content of the material being dried, drying rate, wet or dry bulb temperature and/or relative humidity of the drying gas, or integrated amount of moisture removed.

41. An apparatus according to claim 40 where the refrigerant flow control means involves reducing or increasing the heat pump compressor capacity or turning one or more heat pump compressors on or off.

42. A process for drying a material using a drying gas including:
causing a first sub-stream of the drying gas to flow through a heat sink heat exchanger to cool and condense liquid out of the drying gas, with a heat transfer surface arranged to exchange heat with a first sub-stream of the drying gas,
causing a second sub-stream of the gas to flow through a heat source heat exchanger to heat the drying gas, with a heat transfer surface arranged to exchange heat with said second sub-stream of the drying gas, said heat source heat exchanger being arranged in a functionally parallel with said heat sink heat exchanger so that each of said drying gas sub-streams exchanges heat with one of the two said heat transfer surfaces per cycle through the heat exchange system, and
causing the flow direction of the drying gas through the heat sink and heat source heat exchangers to reverse.

43. A drying process with a primarily closed loop recirculation of drying gas that passes over and/or through the material being dried and then over and/or through a means to cool and condense liquid out of a first sub-stream of the drying gas and a means to heat a second sub-stream of the drying gas such that the said drying gas sub-streams will exchange heat by at most one of the two said heating and cooling means per cycle through the process.

44. A drying process according to claim 42 wherein at least part of the heat source heat exchanger is a condenser in a heat pump system.

45. A drying process according to claim 43 where at least part of the heat sink heat exchanger is an evaporator in the heat pump system.

46. A drying process according to any one of claims 42 to 45 including heating the drying gas to a temperature between 25 and 90C.

47. A drying process according to any one of claims 42 to 46 including causing said two gas sub-streams to substantially mix after they have passed through or around said heat sink and heat source heat exchangers.

48. A drying process according to any one of claims 42 to 47 including reversing the drying gas flow direction based on any one or more of drying time, moisture content, wet or dry bulb temperature or relative humidity of the drying gas, or integrated amount of moisture removed from the drying gas.

49. A drying process according to claim 48 including for determining via sensors the dry-bulb and wet-bulb temperatures and/or relative humidity for the drying gas flow entering and/or leaving the dehumidifier.

50. A drying process according to any one of claims 42 to 49 including temporarily reducing the capacity of the heat sink heat exchanger to condense moisture out of the drying gas and/or the capacity of the heat source exchanger to heat the drying gas.

51. A drying process according to any one of claims 42 to 50 including rejecting heat from the drying apparatus to the external environment during the drying.

52. A drying process according to any one of claims 42 to 51 including causing the drying gas to pass over a substantially closed loop path repeatedly through the heat exchange system and past or through a drying chamber for containing a material to be dried.

53. A drying process according to any one of claims 42 to 52 wherein the drying gas is air.

54. A drying process including producing a periodically reversed flow of drying gas that passes through and/or over a material to be dried and through and/or over cold and hot heat exchangers arranged in functionally parallel configuration relative to the drying gas flow.

55. A process according to any one of claims 42 to 53 including cooling and condensing liquid out of a drying gas with a heat sink heat exchanger containing a heat sink medium and a heat sink heat transfer surface comprising two or more sections connected in a functionally parallel configuration with each other arranged to exchange heat with two or more substreams of the drying gas so that each drying gas sub-stream exchanges heat with no more than one of the two or more said heat sink heat transfer surface sections per cycle through the heat exchange system.

56. A drying process according to claim 55 including controlling the flow of heat sink medium in the heat sink heat exchanger sections to increase, decrease, turn on, and/or turn off the flow of heat exchange medium independently in each of the heat sink heat exchanger sections.

57. A process for drying a material including:
causing a drying gas to remove moisture from the material being dried, and
heating the drying gas with a heat source heat exchanger containing a heat source medium, and
cooling and condensing liquid out of a drying gas with a heat sink heat exchanger containing a heat sink medium and a heat sink heat transfer surface comprising two or more sections connected in a functionally parallel configuration with each other arranged to exchange heat with two or more substreams of the drying gas so that each drying gas sub-stream exchanges heat with no more than one of the two or more said heat sink heat transfer surface sections per cycle through the heat exchange system.

58. A drying process according to claim 57 with a control system to control the flow of heat sink medium in the heat sink heat exchanger sections and increase, decrease, turn on, and/or turn off the flow of heat exchange medium independently in each of the heat sink-heat exchanger sections.

59. A drying process according to claim 57 or 58 wherein at least part of the heat sink heat exchanger is an evaporator in a heat pump system.

60. A drying process according to claim 59 wherein at least part of the heat source heat exchanger is a condenser in a heat pump system.

61. A drying process according to any one of claims 57 to 60 including heating the drying gas to a temperature between 25 and 90C.

62. A drying process according to any one of claims 57 to 61 including arranging the drying gas flow path to substantially mix the two or more of the said drying gas sub streams after they have passed through or around said heat sink heat exchanger sections.

63. A drying process according to any one of claims 57 to 62 including sensing the dry-bulb and wet-bulb temperatures, relative humidity for the drying gas flow entering and/or leaving the dehumidifier, drying time and/or other indicator or indicators such as heat sink or source fluid temperature or pressure, moisture content of the material being dried, drying rate, or integrated amount of moisture removed from the system.

64. A drying process according to any one of claims 57 to 63 arranging said control system to be able to temporarily reduce during drying, the overall capacity of the heat sink heat exchanger to condense moisture out of the drying gas and the overall capacity of the heat source exchanger to heat the drying gas.

65. A drying process according to any one of claims 57 to 64 including rejecting heat from the drying apparatus to the external environment such as full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, or partially or wholly condensing the high-pressure refrigerant for purposes of control.

66. A drying process according to any one of claims 57 to 65 arranging the drying gas to pass over a substantially closed loop path repeatedly through the heat exchange system and past or through a drying chamber for containing a material to be dried.

67. A process according to any one of claims 42 to 53, and 55 to 66 for drying a material, carried out using a heat pump and including evaporating the heat pump refrigerant in said heat sink heat exchanger, wherein at least a portion of the heat of evaporation of the refrigerant is transferred by heat exchange from a drying gas medium, and
condensing the heat pump refrigerant in said heat source heat exchanger, after it has been compressed wherein at least a portion of the heat of condensation is transferred by heat exchange to said drying gas medium, and
sensing the wet bulb and dry bulb temperatures of the drying gas, and
rejecting heat from the drying apparatus, and
controlling the amount of heat rejected from the drying apparatus based on the wet bulb temperature of the drying gas wherein the wet bulb temperature is kept nominally constant for an extended period during the drying process, and
controlling the total flow of refrigerant in the heat pump circuit based on the dry bulb temperature of the drying gas wherein the dry bulb temperature is kept within certain limits throughout the drying process.

68. A process for drying a material according to claim 67 wherein heat is rejected from the process to the external environment involving full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, and/or partially or wholly condensing the high-pressure refrigerant.

69. A process for drying a material according to either one of claims 67 and 68 with said control for changing the rate of heat rejection from the drier based on drying time and/or other indicator or indicators such as refrigerant temperature or pressure, moisture content of the material being dried, drying rate, wet or dry bulb temperature and/or relative humidity of the drying gas, or integrated amount of moisture removed.

70. A process for drying a material according to any one of claims 67 to 69 with said control for changing the total system refrigerant flow based on drying time and/or other indicator or indicators such as refrigerant temperature or pressure, moisture content of the material being dried, drying rate, wet or dry bulb temperature and/or relative humidity of the drying gas, or integrated amount of moisture removed.

71. A process for drying a material according to claim 70 where the refrigerant flow control involves reducing or increasing the heat pump compressor capacity or turning one or more heat pump compressors on or off.

72. A heat pump based process for drying a material comprising:
evaporating the heat pump refrigerant wherein at least a portion of the heat of evaporation of the refrigerant is transferred by heat exchange from a drying gas medium, and
condensing the heat pump refrigerant after it has been compressed wherein at least a portion of the heat of condensation is transferred by heat exchange to a drying gas medium, and
sensing the wet bulb and dry bulb temperatures of the drying gas, and
rejecting heat from the drying apparatus, and
controlling the amount of heat rejected from the drying apparatus based on the wet bulb temperature of the drying gas wherein the wet bulb temperature is kept nominally constant for an extended period during the drying process, and
controlling the total flow of refrigerant in the heat pump circuit based on the dry bulb temperature of the drying gas wherein the dry bulb temperature is kept within certain limits throughout the drying process.

73. A heat pump based process for drying a material according to claim 72 wherein heat is rejected from the process to the external environment involving full time or periodic drying gas venting, pre-cooling the drying gas entering the evaporator, pre-cooling any make-up or purge drying gas entering or leaving the apparatus, sub-cooling the liquid heat pump refrigerant after it leaves the condenser and before it enters the evaporator, de-superheating the heat pump refrigerant leaving the compressor, and/or partially or wholly condensing the high-pressure refrigerant.

74. A heat pump based process for drying a material according to claim 72 or 73 operating with drying gas temperatures between 25 and 90C.

75. A heat pump based process for drying a material according to any one of claims 72 to 74 using air as the drying gas.

76. A heat pump based process for drying a material according to any one of claims 72 to 75 with said control for changing the rate of heat rejection from the drier based on drying time and/or other indicator or indicators such as refrigerant temperature or pressure, moisture content of the material being dried, drying rate, wet or dry bulb temperature and/or relative humidity of the drying gas, or integrated amount of moisture removed.

77. A heat pump based process for drying a material according to any one of claims 72 to 76 with said control for changing the total system refrigerant flow based on drying time and/or other indicator or indicators such as refrigerant temperature or pressure, moisture content of the material being dried, drying rate, wet or dry bulb temperature and/or relative humidity of the drying gas, or integrated amount of moisture removed.

78. A heat pump based process for drying a material according to claim 77 where the refrigerant flow control involves reducing or increasing the heat pump compressor capacity or turning one or more heat pump compressors on or off.
